(19) United States
(12) Patent Application Publication
(10) Pub. No.: US 2025/0297841 A1
(43) Pub. Date: Sep. 25, 2025

(54) SPIRAL ADDITIVE MANUFACTURED GRIDS FOR CYLINDRICAL BODIES

(71) Applicant: Raytheon Company, Tewksbury, MA (US)

(72) Inventors: Roy E. Martin III, Shrewsbury, MA (US); Nichols C Day, Tucson, AZ (US)

(21) Appl. No.: 18/612,653

(22) Filed: Mar. 21, 2024

(51) Int. Cl. F42B 15/00; B22F 10/28; B33Y 80/00

(52) U.S. Cl. CPC F42B 15/00; B33Y 80/00; B22F 10/28

(57) ABSTRACT

A tubular structure having a length and a width is provided. The tubular structure includes an outer, inner or no surface along the tubular structure length and a cross-sectional area at the tubular structure width. The tubular structure cross-sectional area remains constant or near-constant along the tubular structure length. The tubular structure also has unit cells on the tubular structure outer, inner or no surface that are formed with a thermal fusion process. Each unit cell of the plurality of unit cells has a repeating triangular configuration along the tubular structure length. The plurality of unit cells forms a spiral pattern along the tubular structure length where the spiral pattern provides improvement in cross sectional-area modulation along the tubular structure length.

### TECHNICAL FIELD

Examples relate to cylindrical structures and more specifically to cylindrical structures having improved strength.

### BACKGROUND

Cylindrical structures can be used in a number of applications, such as cylinders for missile applications, rocket bodies, and air turbines. These cylindrical structures have a varying cross section and can be formed of a metal using a powder bed fusion process. During a powder bed fusion process, a first layer of material is spread over a build platform and subjected to a laser. The laser fuses the first layer of material of the cylinder. A second layer of the material is spread across the first layer of material and fused with the first layer of material. This process is repeated until the cylindrical structure is formed.

Typically, a cross section of the cylindrical structure is varied to minimize material costs associated with fabricating the cylindrical structure while allowing the cylindrical structure to meet various structural requirements. However, since the cross section varies, a first cross section may include less material than a second cross section. By virtue of having a greater amount of material, the second cross section may require additional heating. The additional heating can cause thermal cycling of the first cross section where the first cross section can be subjected to heat for a greater time than is necessary. This thermal cycling can create residual stress and distort the first cross section, which can create a failure point for the cylindrical structure. Moreover, the thermal distortions may require further post processing of the cylindrical structure. Alternately, the distortions can be compensated for by providing additional material where the distortions occur and then further machining where the additional material was added in order to achieve the desired structure.

### BRIEF DESCRIPTION OF DRAWINGS

FIG. 1 illustrates, by way of example, a cylindrical body that includes a tubular structure in accordance with examples.

FIG. 2 shows the tubular structure of FIG. 1, in accordance with examples.

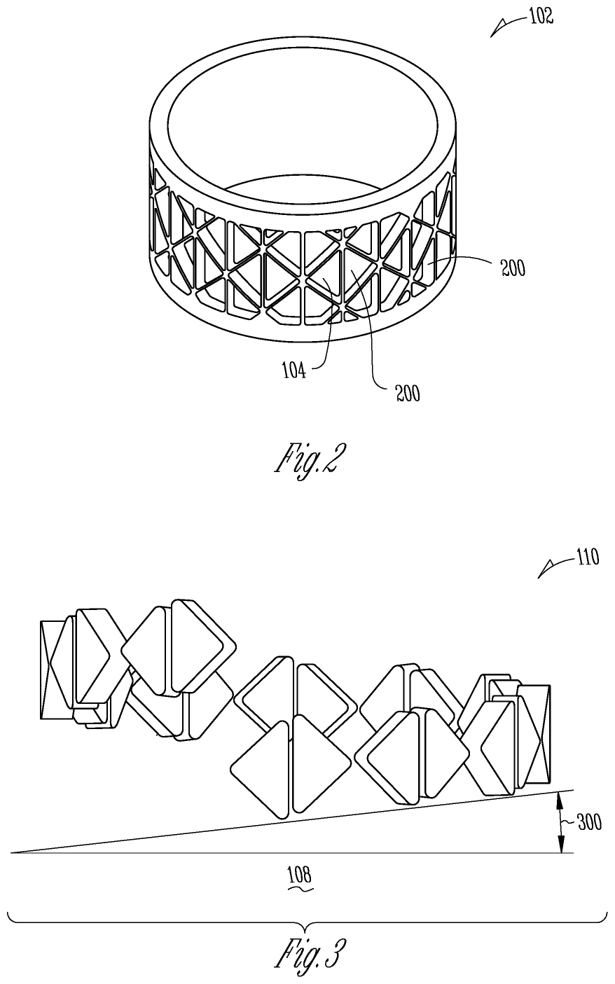

FIGS. 3 and 4 illustrate a configuration of unit cells of the tubular structure of FIGS. 1 and 2, in accordance with examples.

FIGS. 5A and 5B are cross sectional views of FIG. 4 showing a surface area of the tubular structure of FIGS. 1-4, in accordance with examples.

FIG. 6 shows a tubular structure, in accordance with examples.

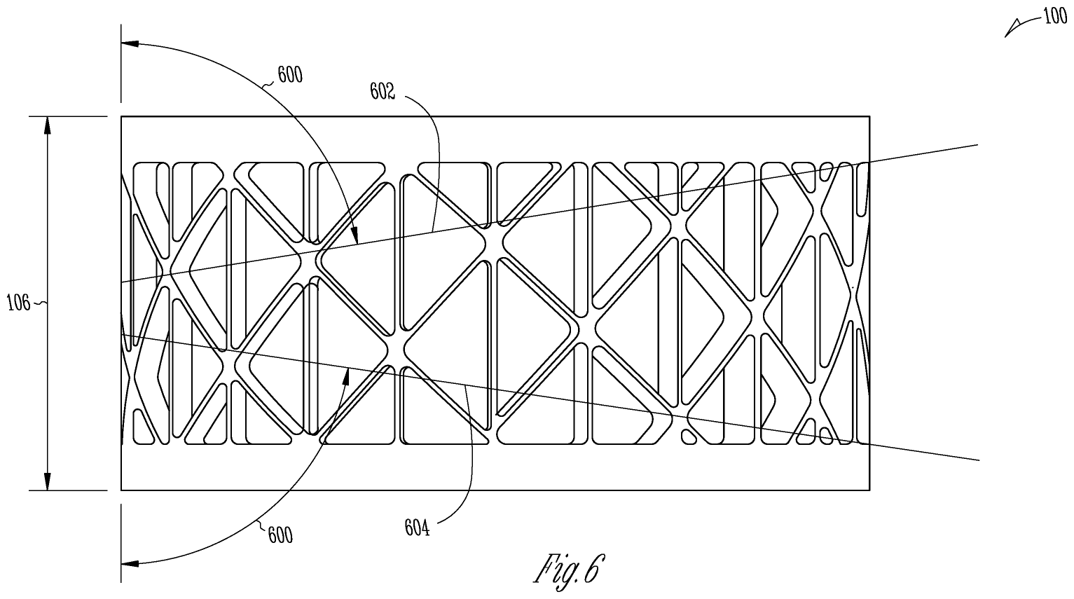

FIGS. 7 and 8 show an alternative configuration of unit cells, in accordance with examples.

FIG. 9 shows an overhang of unit cells of FIGS. 3, 4, 7, and 8, in accordance with examples.

### DETAILED DESCRIPTION

The following description and the drawings sufficiently illustrate teachings to enable those skilled in the art to practice them. Other embodiments may incorporate structural, logical, electrical, process, and other changes. Portions and features of some examples may be included in, or substituted for, those of other examples. Teachings set forth in the claims encompass all available equivalents of those claims.

Examples relate to a tubular structure having unit cells arranged on an outer, inner or no surface in a spiral configuration along a length of the tubular structure. The tubular structure can be formed with an additive process where each of the unit cells can be formed such that a cross-sectional area remains the same along the circumference of the tubular structure. The unit cells can have a triangular configuration, which, when coupled with the spiral configuration about the circumference of the tubular structure, can allow for nearly the same cross-sectional area of the tubular structure along a length of the tubular structure where the unit cells are disposed. In addition to having a triangular configuration, the unit cells can have a configuration that have a shallow overhang from an outer or inner surface of the tubular structure on which the unit cells are disposed. In examples, the triangles can be equilateral triangles, isosceles triangles, or scalene triangles.

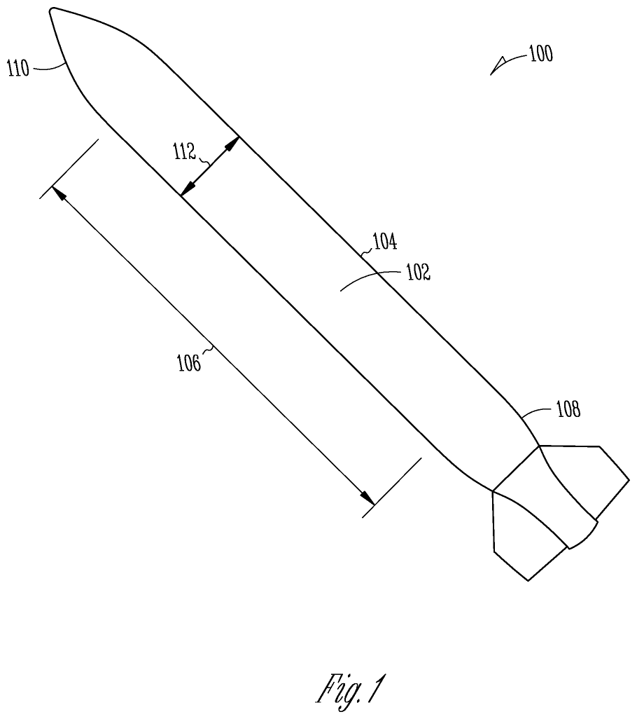

Now making reference to FIG. 1, a cylindrical body 100 is shown having a tubular structure 102. In examples, the cylindrical body 100 can be a projectile. The cylindrical body 100 can have any number of applications, such as a missile, a rocket, an air turbine, or any other structure that uses a hollow tube. While described herein as being circular, the tubular structure can vary in shape, such as a parallelogram, triangular, or the like. The tubular structure 102 can include an outer or inner surface 104 and have a length 106 that extends between an aft portion 108 and a forward portion 110 of the cylindrical body 100. The tubular structure 102 can be hollow and have a width 112, which can allow for the fitment of the tubular structure over a payload being propelled by the cylindrical body 100.

The tubular structure 102 can include a plurality of unit cells 200 arranged on the tubular structure outer or inner surface 104. Reference to the plurality of unit cells 200, the unit cells 200, and the unit cell 200 will be made throughout. Reference to the plurality of unit cells 200 can be applicable to the unit cells 200 or the unit cell 200. Reference to the unit cells 200 can be applicable to the plurality of unit cells 200 or the unit cell 200. Reference to the unit cell 200 can be applicable to the plurality of unit cells 200 or the unit cells 200. The plurality of unit cells 200 can improve a strength of the tubular structure outer or inner surface 104. In particular, the plurality of unit cells 102 can increase a rigidity of the tubular structure 102 and increase the ability of the tubular structure 102 to resist stresses, such as torsional stresses.

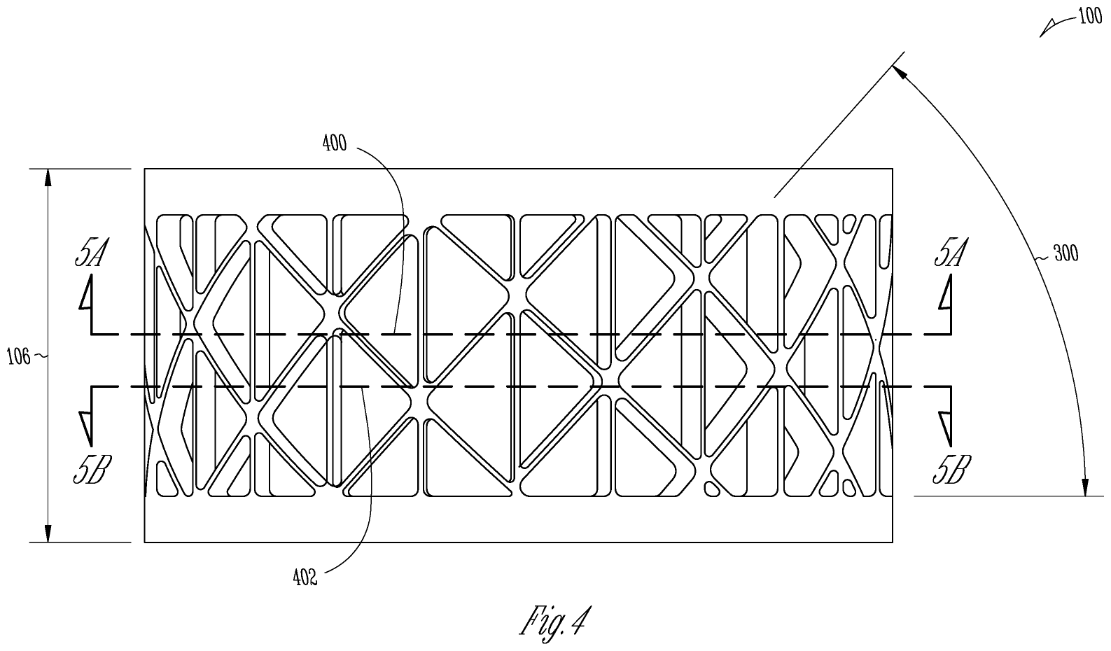

The plurality of unit cells 200 can be arranged on the tubular structure outer, inner or no surface 104 such that each unit cell 200 of the plurality of unit cells 200 form a spiral configuration on the tubular structure outer, inner or no surface 104. The unit cells 200 can repeat on the tubular structure outer, inner or no surface 104 and along the tubular structure length 106. The spiral configuration of the plurality of unit cells 200 on the tubular structure outer, inner or no surface 104 and along the tubular structure length 106 can be characterized as being angled relative to the cylindrical structure aft portion 108 and the cylindrical structure forward portion 110, as shown with reference to FIG. 3. An angle 300 of the plurality of unit cells 200 relative to the tubular structure length 106 and/or the cylindrical structure aft portion 108 and the cylindrical structure forward portion 110 can be in a range between zero and ninety degrees relative to the tubular structure length. Furthermore, the unit cell angle 300 can be forty-five degrees.

By virtue of having the unit cell angle 300 relative to the cylindrical structure aft portion 108 and the cylindrical structure forward portion 110, a cross-sectional area at the tubular structure width 112 can remain nearly the same along the tubular structure length 106 at any angle relative to the tubular structure length 106. For example, at a first cross-section 400 and a second cross-section 402, the tubular structure 102 can have a cross-sectional area 500. The tubular structure cross-sectional area 500 can be defined by portions 502-512 of the plurality unit cells 200 that extend from the tubular structure outer surface 104. The portions can each have unit cell portion cross-sectional areas 514-518 that, combined, can form the tubular structure cross-sectional area 500.

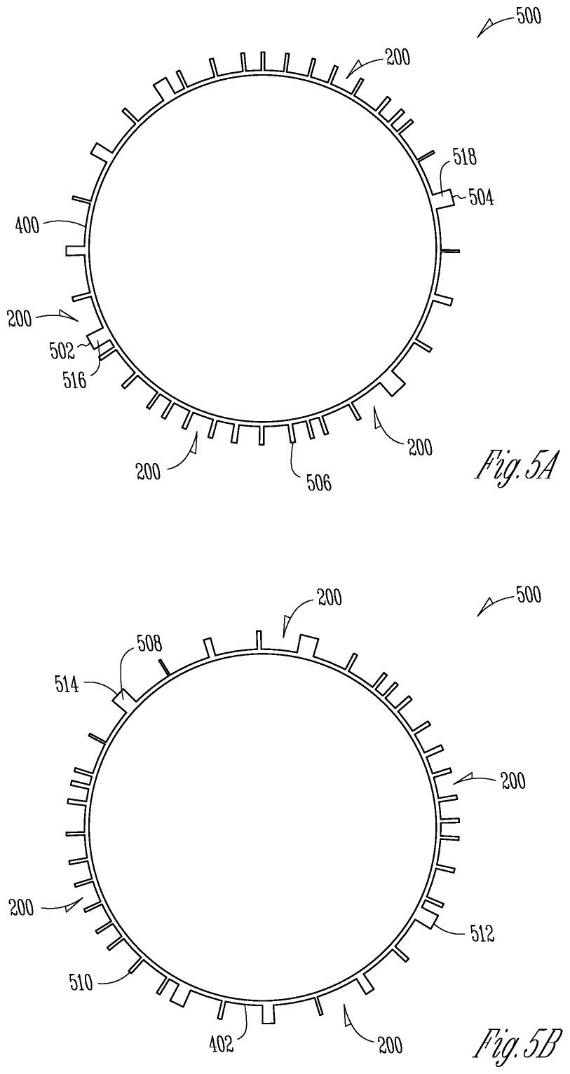

As can be seen with reference to FIGS. 5A and 5B, the portions 502-512 can have different configurations each having different tubular structure portion cross-sectional areas 514-518. However, the combination of the tubular structure portion cross-sectional areas 514-518 along the tubular structure length 106 will be nearly the same such that the tubular structure cross-sectional area 500 is nearly the same along the tubular structure length 106. In particular, by virtue of the plurality unit cells 200 having the spiral configuration, the tubular structure cross-sectional area 500 remains nearly the same along the tubular structure length 106. The portions 502-512 can combine to form triangular sections of the plurality of unit cells 200 such that the unit cells 200 have the triangular configuration shown and discussed throughout. Furthermore, the plurality of unit cells 200 can form equilateral triangles, isosceles triangles, or scalene triangles.

The tubular structure cross-sectional area 500 discussed with reference to FIGS. 5A and 5B is shown as being along the first cross-section 400 and the second cross-section 402, which are ninety degrees relative to the tubular structure length 106. In further examples, regardless of the angle of cross-sections, such as the first cross-section 400 and the second cross-section 402, relative to the tubular structure length 106, the tubular structure cross-sectional area 500 can remain the same along the tubular structure length 106. Thus, a first cross-section 602 and a second cross-section 604 are at tubular structure width angle 600, the tubular structure cross-sectional area 500 can be the same at the first cross-section 602 and the second cross-section 604 as that discussed with reference to FIGS. 5A and 5B. More specifically, regardless of a value of the tubular structure width angle 600, the tubular structure cross-sectional area 500 can remain the same along the tubular structure length 106. In examples, the tubular structure width angle 600 can be in a range of about fifteen degrees to about ninety degrees relative to the tubular structure length 106. In further examples, the tubular structure width angle 600 can be about ninety degrees relative to the tubular structure length 106.

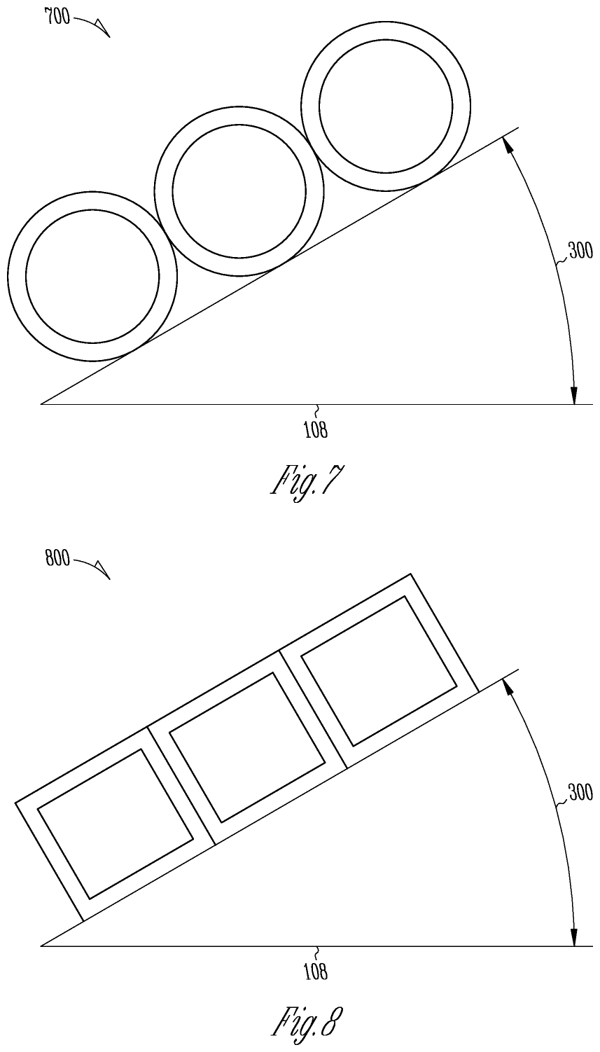

The plurality of unit cells can have configurations other that the triangular configuration described herein. More specifically, the plurality of unit cells can have a circular configuration 700, as shown with reference to FIG. 7. Here, the plurality of unit cells 700 can be in a spiral configuration with the unit cell angle 300 relative to tubular structure length 106 as discussed above. When the plurality of unit cells 700 have the circular configuration, the plurality of unit cells 700 can have the characteristics described with reference to the triangular configuration.

The plurality of unit cells can have a parallelogram configuration, as shown with reference to FIG. 8. Here, the plurality of unit cells 800 can be in a spiral configuration with the unit cell angle 300 relative to tubular structure length 106 as discussed above. Moreover, when the plurality of unit cells 800 have the parallelogram configuration, the plurality of unit cells 800 can have the characteristics described with reference to the triangular configuration.

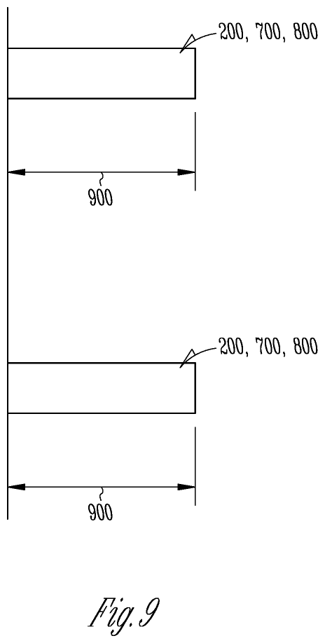

In examples, the plurality of unit cells 200/700/800 can extend from the tubular structure outer surface 104 a distance 900 as shown with reference to FIG. 9. The distance 900 that the plurality of unit cells 200/700/800 can extend from the tubular structure outer or inner surface 104 can be referred to as an overhang. In examples, the distance 900 can be in a range between about twenty thousandths of an inch from the tubular structure outer or inner surface 104 and to about thirty thousandths of an inch from the tubular structure outer or inner surface 104. In further examples, the distance 900 can be in a range between about twenty thousandths of an inch from the tubular structure outer or inner surface 104 and to about a tenth of an inch from the tubular structure outer or inner surface 104.

The tubular structure 102 along with the plurality of unit cells 200 can be formed using any type of additive process, such as laser bed powder fusion, direct energy deposition, or any other thermal deposition process. Further examples of additive processes that can be used can include direct metal laser sintering (DMLS), electron beam melting (EBM), selective heat sintering (SHS), selective laser melting (SLM) and selective laser sintering (SLS), and the like.

Moreover, the tubular structure 102 along with the plurality of unit cells 200 can be formed using an extrusion process, such as hot extrusion, cold extrusion, warm extrusion, friction extrusion, micro-extrusion, or the like. The tubular structure 102 and the plurality of unit cells 200 can be formed from any type of metal or polymer. Examples of metals can include stainless steel, aluminum, or any other type of metal that lends itself to a thermal deposition process or an extrusion process. Examples of polymers that can be used can include thermoplastics, thermosets, elastomers or any other type of polymer that also lends itself to a thermal deposition process or an extrusion process.

While the plurality of unit cells 200/700/800 has been described as forming a continuous spiral around the tubular structure outer surface 104, during formation using the processes described above, the plurality of unit cells 200/700/800 can be interrupted to allow for the formation of other structures along the tubular structure outer or inner surface 104. To further illustrate, features, such as interface surfaces, which can be used to couple the tubular structure 102 to a fixture, bosses, interface through holes, and the like, can be formed in or on the tubular structure outer surface during the formation of the tubular structure and the plurality of the unit cells during the processes described above.

In the examples above, the unit cells were described as being on an outer surface of a structure. In further examples, the unit cells can be disposed on an inner surface of a structure. Furthermore, the structure may not comprise an outer surface or an inner surface on which the unit cells are disposed. Here, the unit cells can define a wall of the structure, which would have the outer surface and the inner surface. Thus, in an examples where the structure does not define an outer or inner surface, the unit cells can replace the outer surface and/or the inner surface.

### Additional Examples

Example 1 is a cylindrical structure comprising: a hollow circular tubular structure having a length and a width, the tubular structure including: an outer surface along the tubular structure length; and a cross-sectional area at the tubular structure width of the tubular structure length, the tubular structure width being at a first angle relative to the tubular structure length, the tubular structure cross-sectional area remaining nearly the same along the tubular structure length; and a plurality of unit cells arranged on the tubular structure outer surface, the plurality of unit cells being formed with a thermal fusion process, wherein: the plurality of unit cells forms a spiral pattern along the tubular structure length from an aft portion of the cylindrical structure to a forward portion of the cylindrical structure where the spiral pattern provides nearly the same cross-sectional area width along the tubular structure length; and each unit cell of the plurality of unit cells has a triangular configuration that repeats along the tubular structure length and is disposed on the tubular structure outer surface at a second angle relative to one of the aft portion or the aft portion.

In Example 2, the subject matter of Example 1 includes, wherein the first angle is in a range between zero and ninety degrees relative to the tubular structure length.

In Example 3, the subject matter of Examples 1 and 2 includes, wherein the first angle is ninety degrees relative to the tubular structure length.

In Example 4, the subject matter of Examples 1-3 includes, wherein the triangular configuration is one of an equilateral triangle, an isosceles triangle, or a scalene triangle.

In Example 5, the subject matter of Example 4 includes, wherein the second angle is in a range between zero and ninety degrees relative to the tubular structure length.

In Example 6, the subject matter of Example 5 includes, wherein the second angle is forty-five degrees.

In Example 7, the subject matter of Examples 1-6 includes, wherein the plurality of unit cells has an overhang that extends in a range between twenty thousandths of an inch from the tubular structure outer or inner surface and a tenth of an inch from the tubular structure outer or inner surface.

Example 8 is a cylindrical structure comprising: a hollow circular tubular structure having a length and a width, the circular tubular structure including: an outer surface along the tubular structure length; and a cross-sectional area at the tubular structure width of the tubular structure length, the tubular structure width being at a first angle relative to the tubular structure length, the cross-sectional area remaining nearly the same along the tubular structure length; and a plurality of unit cells arranged on the tubular structure outer surface, wherein: the plurality of unit cells forms a spiral pattern along the tubular structure length where the spiral pattern provides nearly the same cross-sectional area width along the tubular structure length; and each unit cell of the plurality of unit cells has a configuration that repeats along the tubular structure length and is disposed on the tubular structure outer surface at a second angle relative to one of an aft portion of the tubular structure or a forward portion of the tubular structure.

In Example 9, the subject matter of Example 8 includes, wherein the plurality of cells is formed with a laser powder bed fusion process.

In Example 10, the subject matter of Example 9 includes, wherein the plurality of unit cells has a triangular configuration that is one of an equilateral triangle, an isosceles triangle, or a scalene triangle.

In Example 11, the subject matter of Example 10 includes, wherein the second angle is in a range between fifteen degrees and ninety degrees relative to the tubular structure length.

In Example 12, the subject matter of Example 11 includes, wherein the second angle is forty-five degrees.

In Example 13, the subject matter of Examples 9-12 includes, wherein the plurality of unit cells has circular configuration and each of the plurality of unit cells has an overhang that extends in a range between twenty thousandths of an inch from the tubular structure outer surface and a tenth thirty thousandths of an inch from the tubular structure outer surface.

In Example 14, the subject matter of Examples 9-13 includes, wherein the plurality of unit cells has a configuration that approximates a parallelogram and each of the plurality of unit cells has an overhang that extends in a range between twenty thousandths of an inch from the tubular structure outer surface and a tenth thirty thousandths of an inch from the tubular structure outer surface.

In Example 15, the subject matter of Examples 8-14 includes, wherein the first angle is in a range between fifteen degrees and ninety degrees relative to the tubular structure length.

Example 16 is a cylindrical structure comprising: a tubular structure having a length and a width, the tubular structure including: an outer surface along the tubular structure length; and a cross-sectional area at the tubular structure width of the tubular structure length, the tubular structure width being at a first angle relative to the tubular structure length, the cross-sectional area remaining the same along the tubular structure length; and a plurality of unit cells arranged at the tubular structure outer surface, wherein: the plurality of unit cells forms a spiral pattern along the tubular structure length where the spiral pattern provides the same cross-sectional area width along the tubular structure length; and each unit cell of the plurality of unit cells has a configuration that repeats along the tubular structure length and is disposed on the tubular structure outer surface at a second angle relative to one of an aft portion of the tubular structure or a forward portion of the tubular structure.

In Example 17, the subject matter of Example 16 includes, wherein the plurality of cells is formed with a laser powder bed fusion process.

In Example 18, the subject matter of Example 17 includes, wherein the plurality of unit cells has a triangular configuration that is one of an equilateral triangle, an isosceles triangle, or a scalene triangle and the second angle is forty-five degrees.

In Example 19, the subject matter of Examples 17 and 18 includes, wherein the plurality of unit cells has a circular configuration and each of the plurality of unit cells has an overhang that extends in a range between twenty thousandths of an inch from the tubular structure outer surface and a tenth of an inch from the tubular structure outer surface.

In Example 20, the subject matter of Examples 17-19 includes, wherein the plurality of unit cells has a configuration that approximates a parallelogram and each of the plurality of unit cells has an overhang that extends in a range between twenty thousandths of an inch from the tubular structure outer surface and a tenth of an inch from the tubular structure outer surface.

Example 21 is a system to implement of any of Examples 1-20.

Example 24 is a method to implement of any of Examples 1-20.

Although teachings have been described with reference to specific example teachings, it will be evident that various modifications and changes may be made to these teachings without departing from the broader spirit and scope of the teachings. Accordingly, the specification and drawings are to be regarded in an illustrative rather than a restrictive sense. The accompanying drawings that form a part hereof, show by way of illustration, and not of limitation, specific teachings in which the subject matter may be practiced. The teachings illustrated are described in sufficient detail to enable those skilled in the art to practice the teachings disclosed herein. Other teachings may be utilized and derived therefrom, such that structural and logical substitutions and changes may be made without departing from the scope of this disclosure. This Detailed Description, therefore, is not to be taken in a limiting sense, and the scope of various teachings is defined only by the appended claims, along with the full range of equivalents to which such claims are entitled.

What is claimed is:

1. A cylindrical structure comprising:
a hollow circular tubular structure having a length and a width, the tubular structure including:
an outer surface along the tubular structure length; and
a cross-sectional area at the tubular structure width of the tubular structure length, the tubular structure width being at a first angle relative to the tubular structure length, the tubular structure cross-sectional area remaining nearly the same along the tubular structure length; and
a plurality of unit cells arranged on the tubular structure outer surface, the plurality of unit cells being formed with a thermal fusion process, wherein:
the plurality of unit cells forms a spiral pattern along the tubular structure length from an aft portion of the cylindrical structure to a forward portion of the cylindrical structure where the spiral pattern provides nearly the same cross-sectional area width along the tubular structure length; and
each unit cell of the plurality of unit cells has a triangular configuration that repeats along the tubular structure length and is disposed on the tubular structure outer surface at a second angle relative to one of the aft portion or the aft portion.

2. The cylindrical structure of claim 1, wherein the first angle is in a range between zero and ninety degrees relative to the tubular structure length.

3. The cylindrical structure of claim 1, wherein the first angle is ninety degrees relative to the tubular structure length.

4. The cylindrical structure of claim 1, wherein the triangular configuration is one of an equilateral triangle, an isosceles triangle, or a scalene triangle.

5. The cylindrical structure of claim 4, wherein the second angle is in a range between zero and ninety degrees relative to the tubular structure length.

6. The cylindrical structure of claim 5, wherein the second angle is forty-five degrees.

7. The cylindrical structure of claim 1, wherein the plurality of unit cells has an overhang that extends in a range between twenty thousandths of an inch from the tubular structure outer or inner surface and a tenth of an inch from the tubular structure outer or inner surface.

8. A cylindrical structure comprising:
a hollow circular tubular structure having a length and a width, the circular tubular structure including:
an outer surface along the tubular structure length; and
a cross-sectional area at the tubular structure width of the tubular structure length, the tubular structure width being at a first angle relative to the tubular structure length, the cross-sectional area remaining nearly the same along the tubular structure length; and
a plurality of unit cells arranged on the tubular structure outer surface, wherein:
the plurality of unit cells forms a spiral pattern along the tubular structure length where the spiral pattern provides nearly the same cross-sectional area width along the tubular structure length; and
each unit cell of the plurality of unit cells has a configuration that repeats along the tubular structure length and is disposed on the tubular structure outer surface at a second angle relative to one of an aft portion of the tubular structure or a forward portion of the tubular structure.

9. The cylindrical structure of claim 8, wherein the plurality of cells is formed with a laser powder bed fusion process.

10. The cylindrical structure of claim 9, wherein the plurality of unit cells has a triangular configuration that is one of an equilateral triangle, an isosceles triangle, or a scalene triangle.

11. The cylindrical structure of claim 10, wherein the second angle is in a range between fifteen degrees and ninety degrees relative to the tubular structure length.

12. The cylindrical structure of claim 11, wherein the second angle is forty-five degrees.

13. The cylindrical structure of claim 9, wherein the plurality of unit cells has circular configuration and each of the plurality of unit cells has an overhang that extends in a range between twenty thousandths of an inch from the tubular structure outer surface and a tenth of an inch from the tubular structure outer surface.

14. The cylindrical structure of claim 9, wherein the plurality of unit cells has a configuration that approximates a parallelogram and each of the plurality of unit cells has an overhang that extends in a range between twenty thousandths of an inch from the tubular structure outer surface and a tenth of an inch from the tubular structure outer surface.

15. The cylindrical structure of claim 8, wherein the first angle is in a range between fifteen degrees and ninety degrees relative to the tubular structure length.

16. A cylindrical structure comprising:
a tubular structure having a length and a width, the tubular structure including:
an outer surface along the tubular structure length; and
a cross-sectional area at the tubular structure width of the tubular structure length, the tubular structure width being at a first angle relative to the tubular structure length, the cross-sectional area remaining the same along the tubular structure length; and
a plurality of unit cells arranged at the tubular structure outer surface, wherein:
the plurality of unit cells forms a spiral pattern along the tubular structure length where the spiral pattern provides the same cross-sectional area width along the tubular structure length; and
each unit cell of the plurality of unit cells has a configuration that repeats along the tubular structure length and is disposed on the tubular structure outer surface at a second angle relative to one of an aft portion of the tubular structure or a forward portion of the tubular structure.

17. The cylindrical structure of claim 16, wherein the plurality of cells is formed with a laser powder bed fusion process.

18. The cylindrical structure of claim 17, wherein the plurality of unit cells has a triangular configuration that is one of an equilateral triangle, an isosceles triangle, or a scalene triangle and the second angle is forty-five degrees.

19. The cylindrical structure of claim 17, wherein the plurality of unit cells has a circular configuration and each of the plurality of unit cells has an overhang that extends in a range between twenty thousandths of an inch from the tubular structure outer surface and a tenth of an inch from the tubular structure outer surface.

20. The cylindrical structure of claim 17, wherein the plurality of unit cells has a configuration that approximates a parallelogram and each of the plurality of unit cells has an overhang that extends in a range between twenty thousandths of an inch from the tubular structure outer surface and a tenth of an inch from the tubular structure outer surface.
